(19) United States
(12) Patent Application Publication
(10) Pub. No.: US 2026/0001208 A1
(43) Pub. Date: Jan. 1, 2026

(54) TOOL HAVING A SEALING POCKET FOR AN ELECTRICAL COMPONENT

(71) Applicant: BLACK & DECKER INC., New Britain, CT (US)

(72) Inventors: Daniel KADLECEK, Bischofsheim (DE); Tobias DEMANT, Wiesbaden (DE)

(21) Appl. No.: 19/255,226

(22) Filed: Jun. 30, 2025

(30) Foreign Application Priority Data
Jul. 1, 2024 (EP) 24185800.0

(51) Int. Cl. B25F 5/02

(52) U.S. Cl. CPC B25F 5/02

(57) ABSTRACT

A tool comprising: a housing for housing components of the tool, the housing comprising a first housing element and a second housing element, the first and second housing elements being configured to cooperate with each other to form the housing, where the first housing element includes a pocket; a sealing material disposed in the pocket; an electrical component disposed at least partially in the pocket; and a further component located exterior to the pocket within the housing. The tool is configured such that, where the first housing element and the second housing element are in cooperative engagement, a sealing portion of the second housing element abuts the electrical component whereby the electrical component is sealed by the sealing material.

### CROSS-REFERENCE TO RELATED APPLICATIONS

This application claims priority to EP patent application Ser. No. 24/185,800.0, filed on Jul. 1, 2024, which is incorporated herein by reference in its entirety.

### FIELD OF THE INVENTION

The present invention relates to tools having one or more sealing pockets for electrical components. For example, a tool can have a sealing pocket for sealing a wire-wire connection.

### BACKGROUND OF THE INVENTION

Electrically-operated tools such as power tools comprise electrical components. These electrical components control the operation of the tool. These electrical components include components such as connectors, printed circuit boards (PCBs) and other electrical components. Tools may come into contact with water or condensation during use and/or storage. For example, a tool may be used outside in the rain. A tool may be intended for use with or near water. For example, the tool may be used with a water hose. An example of such a tool is a pressure washer. A tool may be stored in an environment where condensation may occur, such as in an outside shed or garage.

Electrical components are sensitive to water. For example, water ingress into a tool housing, and/or water condensation within a tool housing, can affect electrical signals of the electrical components, such as by shorting one or more signals. This can deleteriously affect operation of the tool. In some cases, the presence of water on or near the electrical components can pose a safety risk. The presence of water on or near the electrical components can damage the electrical components.

Electrical components can be protected from water by using silicone grease, overmoulding the components on the PCB, or by using UV-cured glue. These approaches lead to difficulties in maintaining the electrical components.

It is desirable to protect electrical components of a tool from water in a way that aids maintenance.

### SUMMARY OF THE INVENTION

According to an aspect of the present invention, there is provided a tool comprising: a housing for housing components of the tool, the housing comprising: a first housing element and a second housing element, the first and second housing elements being configured to cooperate with each other to form the housing, the first housing element comprising a pocket; a sealing material disposed in the pocket; an electrical component disposed at least partially in the pocket; and a further component located exterior to the pocket within the housing; the tool being configured such that, where the first housing element and the second housing element are in cooperative engagement, a sealing portion of the second housing element abuts the electrical component whereby the electrical component is sealed by the sealing material.

In an embodiment, the sealing material suitably fills the pocket.

In an embodiment, the sealing portion of the second housing element comprises a second pocket, and additional sealing material disposed in the second pocket. The tool is suitably configured so that, where the first housing element and the second housing element are in cooperative engagement, the pocket and the second pocket at least partially overlap one another.

In an embodiment, where the first housing element and the second housing element are in cooperative engagement, the pocket aligns with the second pocket. One or more walls forming the pocket may align with one or more walls forming the second pocket.

In an embodiment, the tool is configured to encapsulate the electrical component in the sealing material and/or the additional sealing material.

In an embodiment, the pocket comprises an opening or cut-out in which a wire coupled to the electrical component can be located. The pocket may comprise a plurality of openings or cut-outs. Suitably, the pocket comprises two openings or cut-outs.

The one or more openings or cut-outs can be located to direct bulging sealing material and/or bulging additional sealing material in a desired direction.

In an embodiment the sealing material and/or the additional sealing material may comprise a gel. Suitably the sealing material and/or the additional sealing material is non-adhesive. Providing a non-adhesive sealing material can assist with maintenance of the tool. The sealing material and/or the additional sealing material may comprise an elastomeric material. Suitably the sealing material and/or the additional sealing material has a pre-hardening viscosity (if it is to be hardened, for example where the sealing material and/or the additional sealing material comprises a 2K gel) of at least approximately 300 mPas. Suitably the sealing material and/or the additional sealing material has a viscosity of up to 1500 mPas. In one example, the sealing material and/or the additional sealing material has a viscosity of approximately 1000 mPas. After the sealing material and/or the additional sealing material hardens, the viscosity will increase. The hardened viscosity suitably approximates the viscosity of silicone sealant.

In an embodiment, the sealing portion of the second housing element may comprise an outer shell of the second housing element. The sealing portion of the second housing element may comprise a protrusion extending internally from the outer shell of the second housing element.

In an embodiment, the first housing element is suitably releasably attachable to the second housing element. This arrangement permits ease of assembly and maintenance. Suitably, there is an attachment point near to or adjacent the pocket. Providing an attachment point near to or adjacent the pocket can help maintain the sealing of the electrical component by the sealing material, for example by the cooperative action of the sealing material and the sealing portion of the second housing element. Providing the attachment point near to or adjacent the pocket can reduce the requirements on the material forming the first and/or second housing elements. For example, it need not be as rigid, which can mean that the material forming the first and/or second housing elements may be one or more of: thinner, lighter, a cheaper material to manufacture, than otherwise.

In an embodiment, the releasable attachment between the first and second housing elements can be effected using one or more of a screw attachment, a hinge, a clasp and a clip. Where a screw attachment is provided, a screw boss for receiving a screw can be provided near to or adjacent the pocket. For example, the screw boss can be provided in a wall of the pocket.

In an embodiment, the pocket and the sealing portion of the second housing element may comprise cooperating engagement elements, such as clips, to assist in holding the sealing portion of the second housing element and the pocket together.

According to another aspect of the present invention, there is provided a method of manufacturing a tool, the method comprising: obtaining a housing for housing components of the tool, the housing comprising a first housing element and a second housing element, the first and second housing elements being configured to cooperate with each other to form the housing, the first housing element comprising a pocket; depositing sealing material in the pocket; locating an electrical component of the tool on the sealing material; locating a further component exterior to the pocket within the housing; and assembling the first housing element and the second housing element together to form the housing, causing a sealing portion of the second housing element to abut the electrical component whereby the electrical component is sealed by the sealing material.

In an embodiment, locating the further component exterior to the pocket within the housing suitably comprises locating the further component on or in the first housing element. Suitably the method comprises filling the pocket with the sealing material. This can improve the sealing of the electrical component by the sealing material as the housing is assembled.

In an embodiment, the sealing material and/or the additional sealing material comprises two components: a gel and a hardener. Suitably the deposition and/or hardening of the sealing material and/or the additional sealing material is performed at or above 10 degrees Celsius. The deposition is suitably performed at or above 15 degrees Celsius. The deposition is suitably performed at up to approximately 30 degrees Celsius. The deposition is suitably performed at up to approximately 35 degrees Celsius. Suitably the working temperature range at which the sealing material and/or the additional sealing material are deposited is approximately 15-30 degrees Celsius.

In an embodiment, the method may comprise forming the pocket in the first housing element. The method may comprise forming one or both of the first housing element and the second housing element. Forming one or both housing elements, and/or forming the pocket in the first housing element, as part of a process in which sealing material is deposited in the pocket can improve the efficiency of manufacture. Forming the pocket as part of the manufacturing process can allow the shape and/or size and/or orientation of the pocket to be selected as desired, for example to contain a given electrical component. The choice of the size and/or shape of the pocket means that a volume of sealing material required can be optimised. Such optimisation can help keep costs down. The choice of the orientation of the pocket can help optimise locations within the housing, for example to reduce connector wiring lengths. Such optimisation can help keep costs down.

In an embodiment, assembling the first and second housing elements together causes the electrical component to be depressed into the sealing material thereby causing the sealing material to bulge around the electrical component, for example at least partially encapsulating the electrical component.

In an embodiment, the sealing portion of the second housing element may comprise a second pocket and additional sealing material disposed in the second pocket. The method may comprise depositing the additional sealing material in the second pocket. The method suitably comprises filling the second pocket with the additional sealing material. Filling the second pocket with the additional sealing material can improve the sealing of the electrical component on assembling the housing. The sealing material and the additional sealing material may be the same material.

In an embodiment, the method may comprise forming the second pocket in the second housing element. Forming the second pocket in the second housing element as part of a process in which additional sealing material is deposited in the second pocket can improve the efficiency of manufacture. Forming the second pocket as part of the manufacturing process can allow the shape and/or size and/or orientation of the second pocket to be selected as desired, for example to contain a given electrical component, and/or to cooperate with the pocket in the first housing element. This choice of the size and/or shape of the second pocket means that a volume of additional sealing material required can be optimised. Such optimisation can help keep costs down. The choice of the orientation of the second pocket can help optimise locations within the housing, for example to reduce connector wiring lengths. Such optimisation can help keep costs down.

In an embodiment, the method may comprise assembling the first and second housing elements so that the pocket and the second pocket overlap one another. One or more walls of the pocket may overlap with one or more walls of the second pocket. Suitably, the method comprises assembling the first and second housing elements so that the pocket and the second pocket align with one another. One or more walls of the pocket may align with one or more walls of the second pocket.

In an embodiment, the method may comprise aligning a wire coupled to the electrical component with an opening or cut-out in the pocket. Suitably the opening or cut-out is provided in a wall of the pocket. The method may comprise aligning a plurality of wires, each coupled to the electrical component, with a respective opening or cut-out in the pocket. This arrangement can help reduce the risk of damage occurring to the wire or wires as the housing is assembled.

In an embodiment, the method comprises locating the one or more openings or cut-outs to direct bulging sealing material and/or bulging additional sealing material in a desired direction.

In an embodiment, the sealing portion of the second housing element may comprise an outer shell of the second housing element. The sealing portion of the second housing element may comprise a protrusion extending internally from the outer shell of the second housing element.

In an embodiment, assembling the first housing element and the second housing element may comprise releasably attaching the first housing element and the second housing element together. This arrangement permits ease of assembly and maintenance. The method may comprise providing an attachment point near to or adjacent the pocket. Providing an attachment point near to or adjacent the pocket can help maintain the sealing of the electrical component by the sealing material, for example by the cooperative action of the sealing material and the sealing portion of the second housing element. Providing the attachment point near to or adjacent the pocket can reduce the requirements on the material forming the first and/or second housing elements. For example, it need not be as rigid, which can mean that the material forming the first and/or second housing elements may be one or more of: thinner, lighter, a cheaper material to manufacture, than otherwise.

In an embodiment, the releasable attachment between the first and second housing elements can be effected using one or more of a screw attachment, a hinge, a clasp and a clip. Where a screw attachment is provided, a screw boss for receiving a screw can be provided near to or adjacent the pocket. For example, the screw boss can be provided in a wall of the pocket. Assembling the first and second housing elements to form the housing may comprise screwing the first and second housing elements together. Assembling the first and second housing elements to form the housing may comprise screwing a screw into a screw boss formed near to or adjacent the pocket in the first housing element. Assembling the housing may comprise screwing a screw into a screw boss formed in a wall of the pocket.

In an embodiment, the pocket and the sealing portion of the second housing element may comprise cooperating engagement elements, such as clips, to assist in holding the sealing portion of the second housing element and the pocket together. Assembling the housing may comprise releasably attaching the pocket to the sealing portion.

According to another aspect of the present invention, there is provided a housing for a tool having an electrical component, the housing comprising:
a. a first housing element having
i. a pocket integrated therein, the pocket being for receiving a sealing material and the electrical component; and
ii. a region adjacent the pocket for receiving a further component; and
b. a second housing element configured for cooperative engagement with the first housing element to form the housing, the second housing element having a sealing portion for sealing against the pocket.

In an embodiment, the housing suitably comprises a sealing material disposed in the pocket. The sealing portion suitably comprises a second pocket. The second pocket may comprise additional sealing material. The housing may comprise the electrical component located at least partially in the pocket. The housing may comprise the further component located in the region adjacent the pocket.

According to another aspect of the present invention, there is provided a housing for a tool having an electrical component, the housing comprising:
a. a first housing element having
i. a pocket integrated therein, the pocket being for receiving a sealing material and the electrical component; and
ii. a region adjacent the pocket for receiving a further component;
b. the first housing element being configured for cooperative engagement with a second housing element for sealing against the pocket.

In an embodiment, the housing suitably comprises a sealing material disposed in the pocket. The housing may comprise the electrical component located at least partially in the pocket. The housing may comprise the further component located in the region adjacent the pocket.

According to another aspect of the present invention, there is provided a method of manufacturing a tool, the method comprising:
a. obtaining a housing for housing components of the tool, the housing comprising
i. a first housing element having:
1. a pocket integrated therein, the pocket being for receiving a sealing material and an electrical component; and
2. a region adjacent the pocket for receiving a further component; and
ii. a second housing element configured for cooperative engagement with the first housing element to form the housing, the second housing element having a sealing portion for sealing against the pocket; and
b. depositing sealing material in the pocket.

In an embodiment, the sealing portion suitably comprises a second pocket. The method may comprise depositing additional sealing material in the second pocket. The method may comprise locating the electrical component at least partially in the pocket. The method may comprise locating the further component in the region adjacent the pocket.

According to another aspect of the present invention, there is provided a method of manufacturing a tool, the method comprising:
a. obtaining a housing for housing components of the tool, the housing comprising a first housing element having:
i. a pocket integrated therein, the pocket being for receiving a sealing material and an electrical component; and
ii. a region adjacent the pocket for receiving a further component;
b. the first housing element being configured for cooperative engagement with a second housing element for sealing against the pocket; and
c. depositing sealing material in the pocket.

In an embodiment, the method may comprise locating the electrical component on the sealing material. The method may comprise locating the further component in the region adjacent the pocket.

### BRIEF DESCRIPTION OF THE DRAWINGS

Examples will now be described in detail with reference to the accompanying drawings in which:

FIG. 1 illustrates an example first housing element for a tool housing;

FIG. 2 illustrates an example second housing element, for cooperative engagement with the first housing element of FIG. 1;

FIG. 3 illustrates first and second housing elements comprising respective pockets;

FIG. 4 illustrates a different side view of the pockets of FIG. 3;

FIG. 5A illustrates an electrical component provided between the pockets of FIG. 3;

FIG. 5B illustrates the first and second housing elements of FIG. 5A in an assembled configuration;

FIG. 5C illustrates another example arrangement of a pocket and a second pocket;

FIG. 6 illustrates another example of first and second housing elements comprising respective pockets;

FIG. 7 illustrates an arrangement of a second housing element comprising a protruding sealing portion;

FIG. 8 illustrates another arrangement of a second housing element comprising a sealing portion;

FIG. 9 illustrates another example of first and second housing elements comprising respective pockets;

FIG. 10 illustrates a side view of another example of first and second housing elements comprising respective pockets;

FIG. 11 illustrates a flow chart of an example method; and

FIG. 12 illustrates a flow chart of another example method.

The accompanying drawings illustrate various examples. Common reference numerals are used throughout the figures, where appropriate, to indicate similar features.

### DETAILED DESCRIPTION OF THE INVENTION

The following description is presented by way of example to enable a person skilled in the art to make and use the invention. The present invention is not limited to the embodiments described herein and various modifications to the disclosed embodiments will be apparent to those skilled in the art.

The present techniques relate to tools having one or more sealing pockets for electrical components. Electrical components can thereby be protected from water, prolonging the lifespan of the electrical component and/or the tool comprising the electrical component. The present techniques provide an efficient way in which electrical components can be protected from water. The present techniques provide a way of protecting electrical components from water that can facilitate ease of maintaining the tool and/or the electrical component of the tool.

Many electrically-operated tools are used outdoors, and/or are stored in environments where condensation may occur, such as sheds or warehouses. Tools that may be operated outside include various different types of tools. Example tools include rammers, plate compactors and core drills, but the present techniques can be used with other types of tools. Other tools may use water in their operation, for example by connecting to a water hose. Such tools include pressure washers. It will be apparent that these tools are merely examples.

The present disclosure describes a housing for a tool that comprises multiple housing elements which cooperate with one another to form the housing. A pocket is formed in one housing element and a sealing material such as gel is disposed in the pocket. A portion of the other housing element is configured to seal against the pocket when the housing elements are assembled to form the housing. Assembling the housing elements to form the housing causes the gel to bulge around and at least partially encapsulate an electrical component of the tool, thereby protecting it from water, such as from water ingress and/or condensation. The housing element is configured to receive a further component of the tool.

The present techniques thus offer a compact system for sealing an electrical component in a tool housing. Existing wire connectors, PCBs and other electrical components can be used. Thus, the present techniques avoid the need to redesign and retest electronic circuitry and provide a cost-effective way in which one or more electronic components can be protected from water (or indeed another liquid).

Typically, a housing for a tool is arranged to house one or more components including electrical components. The housing will typically house one end of an inlet power cable for coupling the tool to a power source, an electrical control such as a switch, a button or knob for actuating the switch, and an outlet power cable for providing power to a motor of the tool. The housing can be provided in multiple parts. Typically two housing elements are provided, each in the form of a clamshell. Each clamshell provides a recessed portion and a rim, so that when the clamshells are assembled together, there is a volume enclosed by the clamshells.

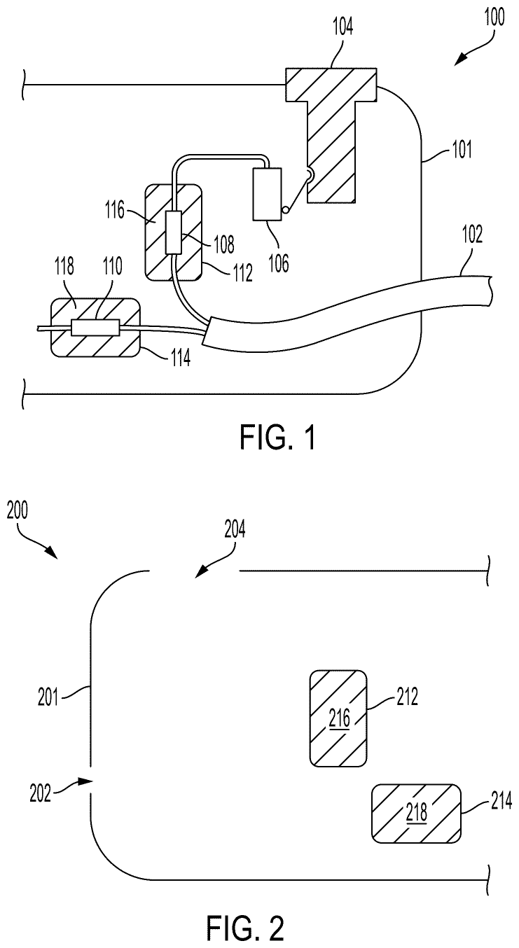

FIG. 1 illustrates a schematic example of a first housing element such as a first clamshell (also called an assembly clamshell). During manufacture, the components are placed in the first housing element before it is covered by a second housing element such as a second clamshell (also called a cover clamshell). The first housing element 100 comprises a first body 101, a power cable 102, and a manual actuator 104 coupled to a switch 106. Wires (only some of which are shown) couple the power cable 102 to electronic components 108, 110. The switch 106 is also coupled to an electronic component 108 by a wire. The full circuit is not shown, for clarity.

The first housing element 100 comprises two pockets 112, 114. Each pocket is arranged to house a respective electrical component 108, 110. The pockets are both filled with a sealing material 116, 118.

FIG. 2 illustrates a schematic example of the second housing element 200, arranged to be assembled with the first housing element. The second housing element comprises a second body 201, a gap 202 for receiving the power cable 102 and another gap 204 for receiving the manual actuator 104. The second housing element 200 comprises two pockets 212, 214. The pockets are both filled with a sealing material 216, 218.

The sealing material used to fill the pockets in the first housing element and the second housing element is the same in this example. The sealing material comprises a non-adhesive gel, such as an elastomeric gel.

When the housing is formed, by assembling the first and second housing elements together, the pockets 212, 214 of the second housing element cover and align with the pockets 112, 114 of the first housing element. When assembled, the sealing material in the pockets 212, 214 of the second housing element is suitably adjacent (touching, or nearly touching) the sealing material in the pockets 112, 114 of the first housing element.

The pockets of the first housing element and the second housing element can be provided in any desired orientation. Suitably, the orientation in which the pockets are provided is selected according to a desired orientation of one or more electrical components to be sealed within the housing.

The housing encloses a volume additional to that of the pockets. That is, there is a region adjacent the pockets within the housing. Referring to FIGS. 1 and 2, this region surrounds the pockets. One or more further component is located in this region.

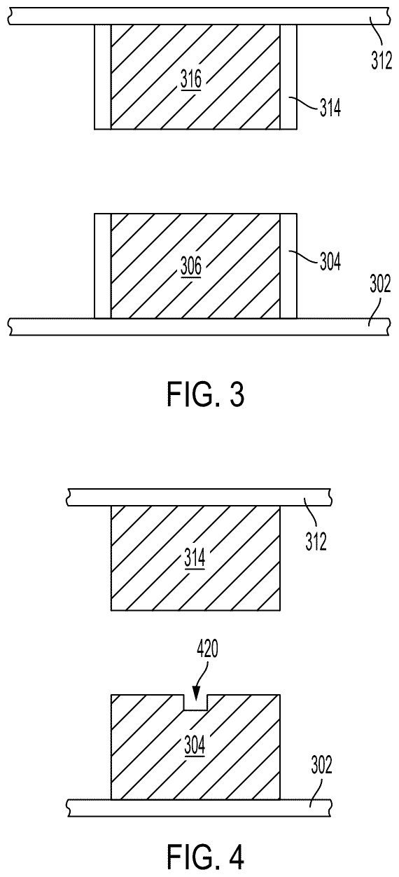

Part of the arrangement of FIGS. 1 and 2 is illustrated in FIG. 3, which provides a side view of the pockets of the housing elements. In the following, the discussion will focus on a single pocket in the first housing element and a single cooperating pocket in the second housing element. However, it will be appreciated that the techniques are not limited to single pockets. Two or more pockets of the first housing element can cooperate with two or more respective pockets of the second housing element.

Turning to FIG. 3, the first housing element 302 comprises a pocket 304 filled with sealing material 306. The pocket 304 is formed by a wall that is upstanding from the body of the first housing element 302. The pocket is suitably formed by a continuous wall that circumscribes the pocket. The second housing element 312 comprises a second pocket 314 filled with additional sealing material 316. The second pocket 314 is formed by a second wall that is upstanding from the body of the second housing element 312. The second pocket is suitably formed by a continuous wall that circumscribes the second pocket.

In FIG. 3, the level of the sealing material 306 can be seen to reach the extent of the wall of the pocket 304 and the level of the additional sealing material 316 can be seen to reach the extent of the wall of the pocket 314. That is, the pockets are filled with the sealing material and additional sealing material, respectively. It will be understood that bringing the first and second housing elements together to form the housing, causing the walls of the pocket to abut the walls of the second pocket, will cause the sealing material of the pocket to come into contact with the additional sealing material of the second pocket.

In the arrangement of FIG. 3, the walls of the pocket align with the walls of the second pocket when the housing is assembled.

FIG. 4 shows an orthogonal side view of the arrangement of FIG. 3. A notch 420 is shown in the wall of the pocket 304. The notch 420 may comprise an opening, a recess and/or a cut-out portion. The opening is provided for receiving a wire that couples to an electrical component to be received in the pocket. Suitably, the opening 420 is small enough that, on filling the pocket with the sealing material, the sealing material 306 does not (or substantially does not) spill out of the opening. For example, the sealing material 306 can be viscous enough that it does not (or substantially does not) spill out of the opening 420.

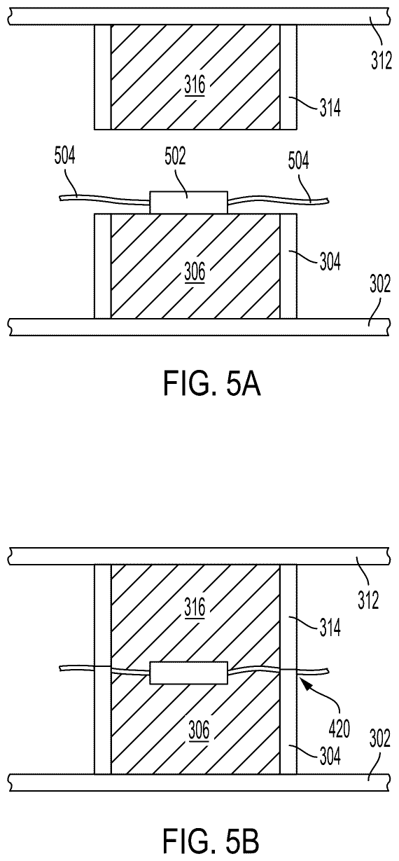

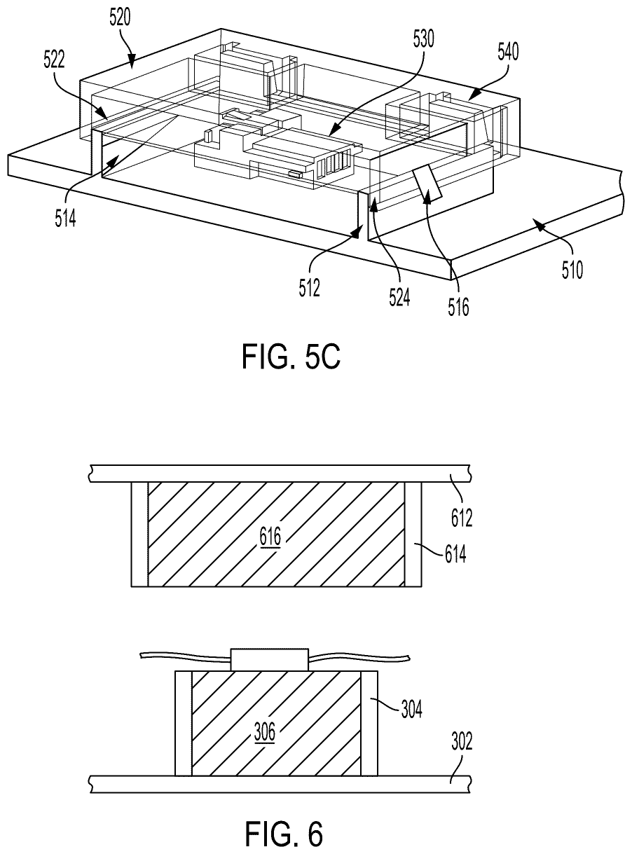

FIGS. 5A and 5B show separated and assembled configurations of the housing, respectively. In the separated configuration of FIG. 5A, the first and second housing elements are arranged as described with respect to FIG. 3. An electrical component 502 is then placed on the sealing material 306. Suitably, the electrical component is placed centrally on the sealing material 306. Suitably, the electrical component 502 is placed such that the sealing material 306 extends to the sides of the electrical component 502.

The second housing element 312 is then placed over the first housing element 302 and the two housing elements are assembled together. As they are brought together, the additional sealing material 316 in the second pocket 314 will come into contact with the electrical component 502. The sealing material and the additional sealing material are resilient. Bringing the additional sealing material into contact with the electrical component will cause a force on the additional sealing material inwardly of the second pocket (upwards in the orientation of FIGS. 5A and 5B) and a force on the electrical component (and on the sealing material) inwardly of the pocket (downwards in the orientation of FIGS. 5A and 5B).

Thus, as the housing is assembled, the electrical component 502 will be partially depressed into the pocket 304. The electrical component 502 will also partially extend into the second pocket 314. The resilient sealing material and additional sealing material will bulge due to the forces exerted and will flow so as to bulge around the electrical component 502. As the housing is assembled, the sealing material will therefore bulge around the electrical component to at least partially encapsulate the electrical component. Further, as the housing is assembled, the additional sealing material will bulge around the electrical component to at least partially encapsulate the electrical component. The bulging of the sealing material and the additional sealing material will cause the electrical component to be encapsulated by the sealing material and the additional sealing material, thereby sealing the electrical component from the environment outside the pocket and the second pocket.

Locating the electrical component so that sealing material is provided around the sides of the electrical component (that is, in plan view, sealing material will be seen to surround the electrical component which is placed on top of the sealing material) advantageously permits the sealing material to bulge around the sides of the electrical component, enhancing the sealing provided by the sealing material.

Whilst not illustrated in FIG. 5B, one or both of the sealing material and the additional sealing material may protrude out through a gap between the walls of the pocket 304 and the walls of the second pocket 314. Such bulging of the sealing material and/or additional sealing material can improve the sealing provided, for example by restricting or preventing liquid ingress into the pocket and/or the second pocket.

Aligning the pocket 304 with the second pocket 314 permits the sealing material to bulge or seep out between the gaps between the wall of the pocket 304 and the wall of the second pocket 314.

Referring again to FIG. 5B, the opening 420 in the wall of the pocket 304 can be aligned with a wire 504 coupled to the electrical component 502. Suitably, as the electrical component 502 is located on the sealing material, the wire 504 is aligned over the opening 420 so that when the electrical component is pushed into the pocket, the wire 504 is pushed into the opening. Suitably, the pocket comprises a number of openings corresponding to a number of wires 504 coupled to the electrical component 502. For example, where the electrical component is a wire connector, two wires will extend from the wire connector. Suitably, therefore, in this example, the pocket 304 will comprise two openings 420. The openings are suitably aligned with the orientation of the wires coupled to the electrical component, for example the openings may be opposite one another.

Integrating the pocket in the first housing element (in the assembly clamshell) can help save cost since an additional structure need not be provided. This arrangement can also help save space, since providing the pocket in the first housing element is space-efficient. Providing the pocket, sized to accommodate the electrical component, helps minimise the amount of sealing material needed. This is because the pocket size can be selected, based on the size of the electrical component to be received in the pocket and sealed by the sealing material.

Integrating the second pocket in the second housing element (in the cover clamshell) can help save cost since an additional structure need not be provided. This arrangement can also help save space, since providing the second pocket in the second housing element is space-efficient. Providing the second pocket, sized to accommodate the electrical component, helps minimise the amount of additional sealing material needed. This is because the second pocket size can be selected, based on the size of the electrical component to be received in the second pocket and sealed by the additional sealing material.

Suitably, the first housing element and the second housing element are releasably attached to one another. The first housing element and the second housing element are suitably attached to one another by a releasable screw attachment. Suitably, the attachment is provided near to or adjacent the pocket in the first housing element and the second pocket in the second housing element. This arrangement allows a greater control of the force with which the electrical component is held between the sealing material and the additional sealing material. Suitably, one of the first housing element and the second housing element comprises a screw boss near to or adjacent the pocket or the second pocket, respectively. Suitably, one or other of the pocket and the second pocket comprises the screw boss. That is, the screw boss can be provided in a wall of the pocket or the second pocket.

The first housing element and the second housing element can be joined together along a hinge. This arrangement permits the easy opening of the housing for maintenance.

Instead of, or as well as, a screw attachment, the housing can comprise one or more of a clamp attachment, a clasp attachment and a clip attachment. In some examples, one or more clips may be provided to secure the pocket to the second pocket. Such an example is illustrated in FIG. 5C, showing a perspective view of an arrangement in which the second pocket extends over, and beyond, the pocket. (This arrangement will be described in more detail with reference to FIG. 6.)

Referring to FIG. 5C, the arrangement comprises a first housing element (an assembly clamshell) 510 having a pocket 512. The pocket is filled with a sealing material (e.g. assembly clamshell gel) 514. The pocket has an opening or cut-out 516 for allowing wires to pass into/out of the pocket. The arrangement comprises a second pocket (cover clamshell pocket) 520 of a second housing element (not shown, for clarity). The second pocket comprises a second pocket wall 524. The second pocket 520 is filled with an additional sealing material (e.g. cover clamshell gel) 522. A wire-wire connection 530 is located between the sealing material 514 and the additional sealing material 522. Clips 540 are provided to releasably secure the pocket to the second pocket.

Suitably the sealing material and the additional sealing material are the same material, but they need not be in all examples. One of the sealing material and the additional sealing material can be stiffer than the other. Selecting the stiffness of each, or the relative stiffness between them, permits control of the captured location of the electrical component within the pocket when the housing is assembled. Providing a relatively stiffer additional sealing material will mean that the electrical component is pressed more firmly into the pocket. Providing a relatively less stiff additional sealing material will mean that the electrical component is pressed less firmly into the pocket.

The sealing material and the additional sealing material have been described as resilient materials. One or both materials can be formed as a gel. Suitably, both the sealing material and the additional sealing material comprise a gel, and the sealing is formed by a gel-on-gel seal between the two. Suitably the sealing material and/or the additional sealing material is non-adhesive. Providing a non-adhesive sealing material can assist with maintenance of the tool since it allows the captured electrical component to be accessed easily on disassembling the housing. The present techniques can still be useful where one or both of the sealing material and the additional sealing material are at least partly adhesive. Such an arrangement can still permit cost-effective manufacture. The sealing material and/or the additional sealing material may comprise an elastomeric material. Suitably the sealing material and/or the additional sealing material has a viscosity of at least 300 mPas. Suitably the sealing material and/or the additional sealing material has a viscosity of up to 1500 mPas. Suitably the sealing material and/or the additional sealing material has a viscosity of approximately 1000 mPas.

In some examples it is not necessary for the sealing material to fill the pocket. In some examples it is not necessary for the additional sealing material to fill the second pocket. It is sufficient that the sealing material and the additional sealing material are caused to bulge around the electrical component on assembling the housing to seal the electrical component. It will be understood that where the volume of the electrical component itself is relatively larger, a greater amount of bulging will be caused on assembling the housing, since the electrical component will displace a greater amount of sealing material and/or additional sealing material. This, in turn, will permit a relatively greater tolerance to the levels of the sealing material and the additional sealing material within the pocket and the second pocket, respectively. That is, where the electrical component is relatively larger, there can be relatively less sealing material and/or additional sealing material whilst still maintaining a good seal.

The pocket and second pocket need not precisely align with one another. That is, walls of the pocket need not precisely align with walls of the second pocket. It is convenient for the walls to align, as this permits the sealing material and/or the additional sealing material to seep through the gap between the wall of the pocket and the wall of the second pocket. However, the sealing material and/or the additional sealing material can be permitted to bulge out through a gap, or seep through a gap, between the pocket and the second pocket in alternative configurations.

It may be sufficient for the sealing material of the pocket to at least partially overlap the additional sealing material of the second pocket. The lateral extent of the second pocket can be smaller or larger than the lateral extent of the pocket. The position of the second pocket can be offset from the position of the pocket.

Example configurations will be described with reference to the drawings. FIG. 6 illustrates an arrangement in which the second pocket is larger in width than the pocket. In this example, the first housing element 302 comprises a pocket 304 in which sealing material 306 is disposed. An electrical component is located on the sealing material. A second housing element 612 comprises a second pocket 614 comprising additional sealing material 616. The second pocket is wider than the pocket. As can be seen from FIG. 6, the left-most part of the second pocket 614 extends to the left of the left-most part of the pocket 304, and the right-most part of the second pocket 614 extends to the right of the right-most part of the pocket 304. In this arrangement, as the housing is assembled, the additional sealing material 616 will contact the electrical component and the walls of the pocket 304. The second housing element can be configured such that the walls of the second pocket ‘overhang’ the walls of the pocket in the assembled configuration of the housing. That is, the pocket can be caused to protrude partly into the second pocket. This arrangement can increase the bulging of the additional sealing material, thereby improving the sealing of the electrical component. Providing one of the pocket and the second pocket to be larger than the other can reduce the accuracy with which the first and second housing elements need to be aligned when assembling the housing. This arrangement can therefore improve the ease of manufacture.

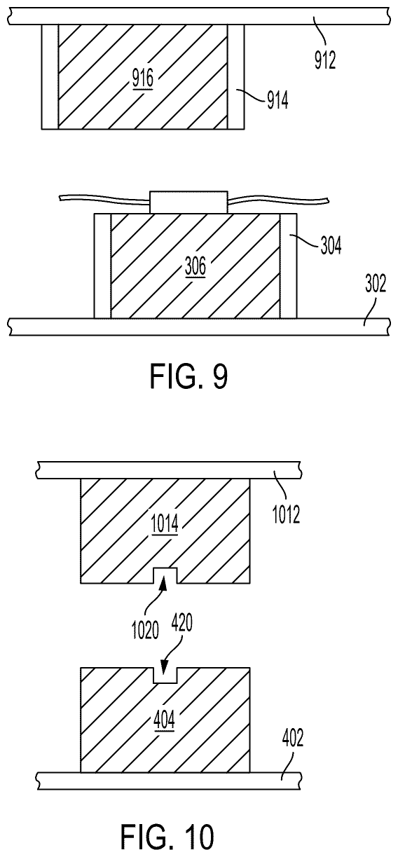

In an alternative configuration, illustrated in FIG. 9, the second pocket can be laterally offset from the pocket. FIG. 9 illustrates an arrangement in which a first housing element 302 comprises a pocket 304 containing sealing material 306. An electrical component is located on the sealing material. A second housing element 912 comprises a second pocket 914 containing additional sealing material 916. In this example, the second pocket is the same size as the pocket, but laterally offset from the pocket. As illustrated, the additional sealing material 916 will cover the electrical component when the second pocket is brought towards the pocket on assembling the housing. Thus, the sealing material and the additional sealing material are able to effectively seal the electrical component. Providing the pocket and the second pocket offset from one another can reduce the accuracy with which the first and second housing elements need to be aligned when assembling the housing. This arrangement can therefore improve the ease of manufacture.

In other examples, the second pocket 914 may be of a different size to the pocket 304, for example larger or smaller.

In any of the configurations discussed herein, the height of the pocket and the height of the second pocket are suitably the same. However, in some examples (of any of the configurations discussed herein) the height of the pocket can be greater than or less than the height of the second pocket.

It is advantageous to provide a second pocket facing the pocket, so that the electrical component is captured between the sealing material and the additional sealing material. That is, it is convenient to capture the electrical component between two resilient materials. This arrangement can help protect the electrical component. This arrangement can improve the sealing of the electrical component.

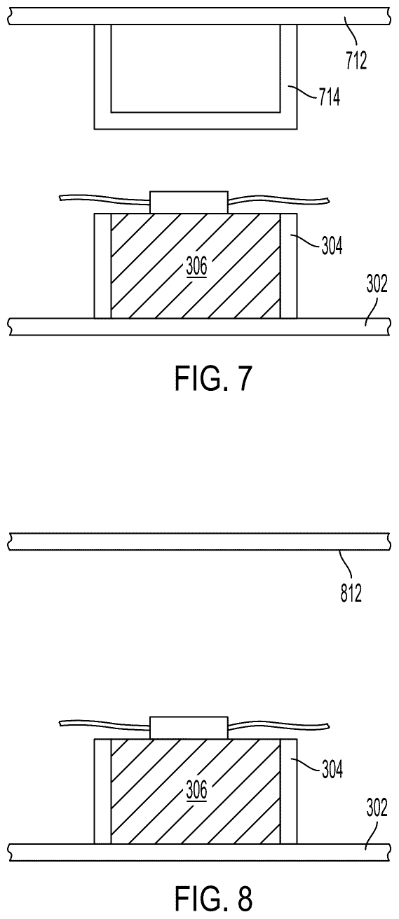

In other examples, the second pocket need not be provided. FIG. 7 illustrates an example in which the second housing element 712 comprises a sealing portion in the form of a protrusion 714. The protrusion may be resilient. As the first housing element 302 and the second housing element 712 are brought together on assembling the housing, the sealing element 714 of the second housing element 712 will exert a force on the electrical component, causing it to be pressed into the sealing material 306. The sealing material will bulge around the electrical component and form a seal against the sealing portion 714. In FIG. 7, the protrusion 714 is shown to be hollow. This is useful to reduce material cost and weight, but is not necessary in all examples. In other examples, the sealing portion 714 can be solid.

The provision of a protrusion permits control of the force exerted on the electrical component as the electrical component is being sealed. On assembling the housing, the first housing element and the second housing element will be located in a known relative position. The height of the protrusion can be reduced, to reduce the force on the electrical component, or increased to increase the force on the electrical component. The force desired to seal the electrical component can be selected in dependence on the electrical component (for example its size and/or shape and/or volume) and/or on the viscosity of the sealing material 306, and/or on the resilience of the protrusion.

In other examples, the sealing portion of the second housing element 812 can comprise an outer wall of the second housing element itself, as illustrated in FIG. 8. In such examples, the outer wall of the second housing element 812 will come into contact with the electrical component as the housing is assembled. This arrangement can permit a slimmer housing to be provided whilst still benefitting from the present techniques.

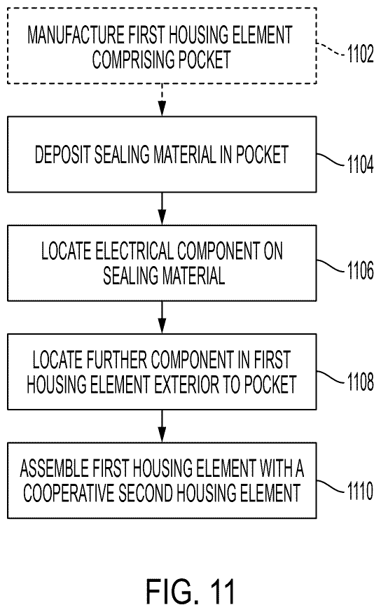

FIG. 4 illustrates an opening or cut-out 420 in the wall of the pocket 404 provided as part of the first housing element 402. In some examples, an opening or cut-out can be provided in the wall of the second pocket as well as or instead of the opening 420 in the wall of the pocket 404. FIG. 10 illustrates an example in which respective openings are provided in the walls of both pockets. As illustrated, a second opening 1020 is provided in a wall of the second pocket 1014 provided as part of the second housing element 1012. Suitably, the second opening 1020 aligns with the opening 420 on assembling the housing. This arrangement can therefore accommodate a larger wire, whilst keeping the opening 420 and the second opening 1020 smaller than a single opening in one of the pocket and second pocket would need to be to accommodate the same size wire. Smaller openings in each can reduce the chance of sealing material (or additional sealing material) flowing through the opening 420 (or the second opening 1020) as the sealing material (or additional sealing material) is deposited in the pocket 404 (or second pocket 1014).

Suitably, the volume of the pocket is up to 50% of the volume of the housing. This arrangement permits sealing of the electrical component in a cost-effective manner. There is no need to fill the entire housing with the sealing material. The volume of the pocket may be up to 40% of the volume of the housing, or up to 30% of the volume of the housing. The volume of the pocket may be smaller than, for example up to, 20% of the volume of the housing or up to 10% of the volume of the housing. It can be advantageous to provide a pocket that is just larger than the electrical component or electrical components that it is to receive. This arrangement permits effective sealing of the electrical component(s) whilst minimising the amount of sealing material needed. It is useful to provide a pocket that is just larger than the electrical component(s) that it is to house so that there is some space for the sealing material to flow around the electrical component(s). Suitably, the space around the electrical component in the pocket is selected in dependent on the viscosity of the sealing material.

It will be understood that more than one component can be included in the pocket. The pocket can be sized appropriately to receive the components. Providing a larger pocket for receiving multiple components may, in some configurations, be more efficient than providing multiple pockets, each having a subset of the multiple components. This may be the case due to a reduction in overall space taken up by the pocket, and/or the amount of sealing material and/or additional sealing material needed.

Reference is now made to FIG. 11, which is a flow chart of a method of manufacturing a tool. An optional first step is to manufacture a first housing element comprising a pocket 1102. The method comprises obtaining the first housing element comprising the pocket but this need not comprise manufacturing the first housing element. Sealing material is then deposited in the pocket 1104. An electrical component is located on the sealing material 1106, and a further component is located in the first housing element exterior to the pocket 1108. The first housing element is then assembled with a second housing element that cooperates with the first housing element to form the housing for a tool 1110. Assembling the first housing element and the second housing element causes the sealing material deposited in the pocket to at least partially encapsulate the electrical component, thereby sealing the electrical component.

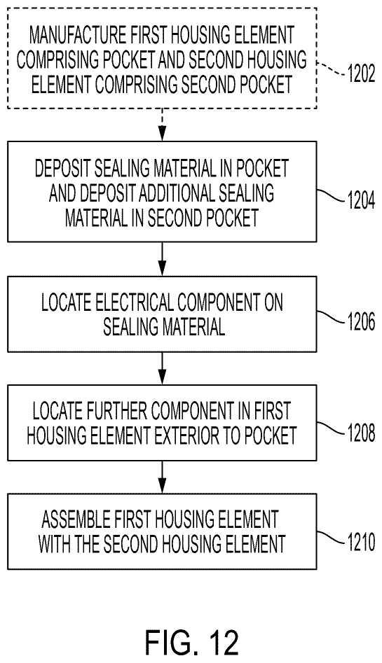

An alternative method will now be described with reference to FIG. 12. An optional first step is to manufacture a first housing element comprising a pocket and a second housing element comprising a second pocket 1202. The method comprises obtaining the first housing element comprising the pocket and the second housing element comprising the second pocket but this need not comprise manufacturing the first housing element or the second housing element. Sealing material is then deposited in the pocket and additional sealing material is deposited in the second pocket 1204. An electrical component is located on the sealing material 1206, and a further component is located in the first housing element exterior to the pocket 1208. The first housing element is then assembled with the second housing element to form the housing for a tool 1210. Assembling the first housing element and the second housing element causes the sealing material deposited in the pocket and the additional sealing material deposited in the second pocket to at least partially encapsulate the electrical component, thereby sealing the electrical component.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

1. A tool comprising:
a housing for housing components of the tool, the housing comprising a first housing element and a second housing element, the first and second housing elements being configured to cooperate with each other to form the housing, wherein the first housing element comprises a pocket;
a sealing material disposed in the pocket;
an electrical component disposed at least partially in the pocket; and
a further component located exterior to the pocket within the housing,
wherein the tool is configured such that, where the first housing element and the second housing element are in cooperative engagement, a sealing portion of the second housing element abuts the electrical component whereby the electrical component is sealed by the sealing material.

2. The tool of claim 1, wherein the sealing portion of the second housing element comprises a second pocket, and additional sealing material is disposed in the second pocket.

3. The tool of claim 2, wherein, where the first housing element and the second housing element are in cooperative engagement, the pocket aligns with the second pocket.

4. The tool of claim 1, wherein the pocket comprises an opening or cut-out in which a wire coupled to the electrical component can be located.

5. The tool of claim 4, wherein the opening or cut-out is located to direct bulging sealing material and/or bulging additional sealing material in a desired direction.

6. The tool of claim 1, wherein at least one of the sealing material or the additional sealing material comprises a non-adhesive gel.

7. The tool of claim 1, wherein the sealing material has a viscosity in the range of 300 mPas to 1500 mPas.

8. The tool of claim 1, wherein the sealing portion of the second housing element comprises an outer shell of the second housing element or a protrusion extending internally from the outer shell of the second housing element.

9. The tool of claim 1, wherein the first housing element is releasably attachable to the second housing element at an attachment point located near to or adjacent the pocket.

10. The tool of claim 9, wherein the releasable attachment between the first and second housing elements comprises a screw attachment, and a screw boss for receiving a screw is provided in a wall of the pocket.

11. The tool of claim 1, wherein the pocket and the sealing portion of the second housing element comprise cooperating engagement elements to assist in holding the sealing portion of the second housing element and the pocket together.

12. A method of manufacturing a tool, the method comprising:
obtaining a housing for housing components of the tool, the housing comprising a first housing element and a second housing element, the first and second housing elements being configured to cooperate with each other to form the housing, the first housing element comprising a pocket;
depositing sealing material in the pocket;
locating an electrical component of the tool on the sealing material;
locating a further component exterior to the pocket within the housing; and
assembling the first housing element and the second housing element together to form the housing, causing a sealing portion of the second housing element to abut the electrical component whereby the electrical component is sealed by the sealing material.

13. The method of claim 12, further comprising filling the pocket with the sealing material.

14. The method of claim 12, further comprising forming the pocket in the first housing element.

15. The method of claim 12, wherein assembling the first and second housing portions causes the electrical component to be depressed into the sealing material thereby causing the sealing material to bulge around the electrical component and at least partially encapsulate the electrical component.

16. The method of claim 12, wherein the second housing element comprises a second pocket, further comprising depositing additional sealing material in the second pocket.
